(19) United States
(12) Patent Application Publication
(10) Pub. No.: US 2025/0225251 A1
(43) Pub. Date: Jul. 10, 2025

(54) VULNERABILITY AND REMEDIATION VALIDATION AUTOMATION

(71) Applicant: DISNEY ENTERPRISES, INC., Burbank, CA (US)

(72) Inventors: Sherwin AGHAMOHAMMAD, Woodland Hills, CA (US); David Alan CARLSTROM, Rocky Hill, CT (US); Eric C. ROSBUROUGH, Santa Clarita, CA (US)

(21) Appl. No.: 18/405,511

(22) Filed: Jan. 5, 2024

(51) Int. Cl. G06F 21/57

(52) U.S. Cl. CPC G06F 21/577; G06F 2221/034

(57) ABSTRACT

A method of qualifying a vulnerability detection for remediation comprising: obtaining a vulnerability detection from a vulnerability scanner for a target system; determining qualification data qualifying the vulnerability detection, wherein the qualification data is based on a configuration of the target system excluded in the vulnerability detection from the vulnerability scanner; and associating the qualification data with the vulnerability detection.

### BACKGROUND

### Field of the Various Embodiments

Embodiments of the present disclosure relate generally to qualifying vulnerabilities detected by vulnerability scanners for remediation.

### Description of the Related Art

Over the past decades, the ongoing trend to computerize corporate records and operations has revolutionized business processes. These trends involve digitizing records, implementing integrated software systems, embracing cloud computing, and leveraging data analytics. This shift enhances efficiency, data accessibility, and decision-making, fostering adaptability in the ever-evolving digital landscape. However, this trend to digitize corporate records and operations has given rise to malicious actors who seek to exploit security vulnerabilities in these computer systems to disrupt operations and/or extort organizations for financial gain.

Security vulnerabilities are weaknesses or flaws in computer systems, software, hardware, or procedures that can be exploited by malicious actors to compromise the confidentiality, integrity, or availability of data, systems, or networks. These vulnerabilities can vary in nature and severity, and they pose a significant risk to the security and privacy of information technology assets. While providing an exact number of new software vulnerabilities identified each year is challenging, the number is typically in the thousands. Because of the evolving nature of security vulnerabilities, best practices in security involve staying informed about security updates, promptly applying patches, and actively monitoring and assessing systems for potential vulnerabilities to mitigate the risks associated with these issues. Vulnerability management software helps organizations scan their systems and applications for known vulnerabilities, prioritize them based on severity, and provide guidance on remediating or mitigating these vulnerabilities.

One problem with commercial vulnerability scanners is that they may simultaneously be over-inclusive and under-inclusive. Vulnerability scanners are under-inclusive when new vulnerabilities emerge and have not yet been incorporated into the scanners. Thus, the security vulnerabilities can go undetected, particularly when they are initially released. Vulnerability scanners are often over-inclusive when they strive to surface all security vulnerabilities instead of identifying only those security vulnerabilities with the highest confidence. This over-inclusive approach can result in false positives. This problem in security vulnerability detection exists because qualifying some vulnerabilities requires additional context not available to commercial vulnerability scanners. As a specific example, one vulnerability often detected by vulnerability scanners relates to anonymous FTP (file transfer protocol), where the security vulnerability involves a malicious actor being able to connect to a target device using FTP and access (read, write, move) files without the target device requiring authentication. A typical commercial vulnerability scanner will perform this detection test by determining that the network port typically identified with FTP (port 21) is open on the target device. This overly simplistic test fails to accurately identify if a malicious actor can log into the target device without authentication and manipulate files. Consider that authentication may, in fact, be present and implemented by FTP or provided at the file system level by the operating system of the target device. In addition, this detection test fails to accurately detect if the FTP user can access files using FTP as access control may again be present at the file system level and implemented by the target device's operating system. As a result of these deficiencies, the commercial vulnerability scanner may identify a problem on a target device with anonymous FTP when none is, in fact, present.

As the forgoing illustrates, what is needed are techniques that properly surface and prioritize critical security vulnerabilities.

### SUMMARY

One embodiment of the present disclosure sets forth a computer-implemented method for qualifying a vulnerability detection for remediation. The method includes obtaining a vulnerability detection from a vulnerability scanner for a target system. The method further includes determining qualification data qualifying the vulnerability detection, wherein the qualification data is based on a configuration of the target system excluded in the vulnerability detection from the vulnerability scanner. The method also includes associating the qualification data with the vulnerability detection.

At least one technical advantage of the disclosed techniques relative to the prior art is that the disclosed techniques automate the prioritization and remediation of security vulnerabilities detected by vulnerability scanners. The proposed techniques qualify the security vulnerabilities detected by the vulnerability scanners by applying additional context to the detected security vulnerabilities to determine if they represent a true security vulnerability requiring remediation. The additional context applied to qualify the vulnerabilities represents one or more configuration elements not considered by the vulnerability scanners. The technical advantages provide one or more technological advancements over the prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a system diagram illustrating a vulnerability qualification system for qualifying vulnerabilities detected by one or more vulnerability scanners.

FIG. 2 is a flow diagram of the vulnerability qualification system, according to one or more embodiments.

FIG. 3 is a block diagram of the configuration data of FIG. 2. for specifying configuration of the vulnerability qualification system, according to one or more embodiments.

FIG. 4 is a block diagram of the raw vulnerability data of FIG. 2. received from vulnerability scanners of the vulnerability qualification system, according to one or more embodiments.

FIG. 5 is a block diagram of the target list of FIG. 2. used as an input to a qualification test 114 of the vulnerability qualification system, according to one or more embodiments.

FIG. 6 is a block diagram of the qualification data of FIG. 2. produced as an output of the qualification test 114 of the vulnerability qualification system, according to one or more embodiments.

FIG. 7A is a conceptual illustration of a flowchart for performing vulnerability qualification, according to various embodiments.

FIG. 7B is a conceptual illustration of a flowchart for performing vulnerability qualification, according to various embodiments.

FIG. 8 is a conceptual illustration of the method operations implemented by the system of FIG. 1, according to various embodiments.

FIG. 9 is a conceptual illustration of exemplary server device hardware.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

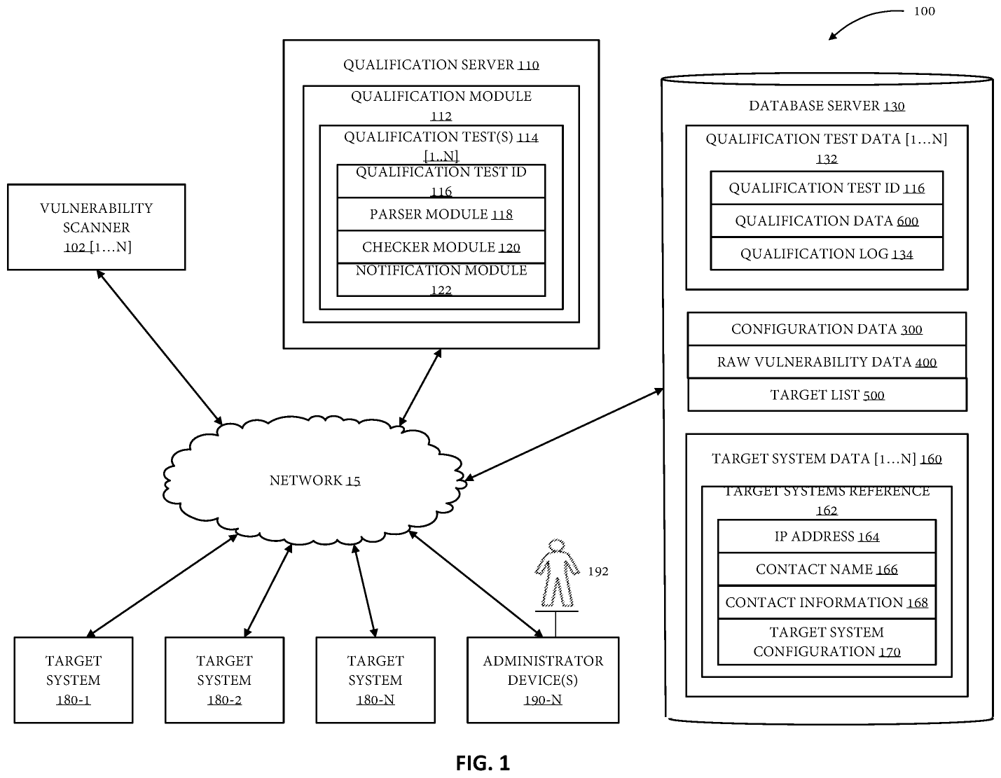

FIG. 1 is a system diagram illustrating a vulnerability qualification system 100 for qualifying vulnerabilities detected (e.g., vulnerability detections) by one or more vulnerability scanners 102. The system includes one or more vulnerability scanners 102, a qualification server 110, a database server 130, one or more target systems 180, and one or more administrator devices 190. As used herein, a vulnerability detection is a vulnerability that has been identified by a vulnerability scanner, such as vulnerability scanner 102. As used herein, qualifying a vulnerability detection is the process of characterizing if a vulnerability detection requires remediation based on examining a configuration of the target system, such as target system 180, excluded in the vulnerability detection from the vulnerability scanner.

As used herein, a vulnerability scanner 102 (vulnerability source) is any computing device operable to execute a vulnerability scanner 102 and produce vulnerability detections. In some embodiments, the vulnerability scanner 102 is a commercial vulnerability scanner. A commercial vulnerability scanner 102 is a software tool or service designed to proactively identify and assess security vulnerabilities within an organization's computer systems, networks, and applications. These vulnerability scanners 102 are provided by commercial software companies and offer a comprehensive approach to security testing. Vulnerability scanners 102 maintain extensive databases of known vulnerabilities, which are regularly updated, and conduct thorough scans of an organization's assets such as target systems 180. Commercial vulnerability scanners generate detailed reports, prioritize vulnerabilities based on their severity, and often provide recommendations for remediation. Vulnerability scanners 102 offer customization options, integration with other security tools, and support compliance checks to ensure adherence to industry standards. These tools are particularly beneficial for larger organizations with complex IT infrastructures, as the tools aid in the continuous monitoring and management of security risks, helping organizations protect their digital assets from potential threats. In some embodiments, the one or more vulnerability scanners 102 are executed from a cloud computing environment and gain access to the target systems 180 on the network 15 through a VPN (virtual private network) or similar means. In some embodiments, the one or more vulnerability scanners 102 are executed from device residing inside the network 15. In some embodiments, a combination of these two approaches is used.

As used herein, a qualification server 110 is a computing device operable to execute the qualification module 112 and persist (store) the results in memory, such as in a database server 130. The qualification server 110 includes a qualification module 112. The qualification module 112 includes one or more qualification tests 114. The qualification tests 114 perform the qualification of the raw vulnerability data 400 produced by the vulnerability scanners 102 to produce the qualification data 600. The qualification tests 114 include a qualification test ID 116, a parser module 118, a checker module 120, and a notification module 122. The parser module 118 scans the raw vulnerability data 400 produced by the vulnerability scanners 102 to create the target list 500 entries (e.g., collated list 502). The collated lists 502 of the target list 500 store related vulnerabilities detected by the vulnerability scanners 102 relating to a single provider vulnerability ID 310. The checker module 120 is responsible for executing the qualification of the collated lists 502 of the target list 500 storing the output as qualification data 600.

As used herein, a database server 130 is any computing device operable to store data accessible through SQL (Structured Query Language) or similar query language. In some embodiments, the qualification server 110 and the database server 130 are the same device. In some embodiments, the database server 130 is a SQL server. An SQL database is a type of relational database that employs a structured and systematic approach to data storage and retrieval. SQL databases are based on the principles of the relational model, where data is organized into tables or “relations,” with each table consisting of rows and columns. This structured format allows for efficient data management, search, and retrieval, making SQL databases a fundamental component of modern information systems. In some embodiments, the database server 130 is replaced by a file system and the elements of the database are instead stored in the file system using one or more of a flat file, XML, JSON, and the like. In some embodiments, a combination of database storage and file system storage is used.

The database server 130 stores qualification test data 132, configuration data 300, raw vulnerability data 400, target list 500, and target system data 160. The qualification test data 132 stores qualification test data for one or more qualification tests 114. Each qualification test data 132 entry includes both data input into the qualification test 114 (such as configuration data 300 and target list 500) and data output from the qualification test 114 (qualification data 600 and qualification log 134). The qualification test data 132 includes a qualification test ID 116, qualification data 600, and a qualification log 134. The qualification test ID 116 uniquely identifies a qualification test 114 among all other qualification test 114. In some embodiments, a CVE (Common Vulnerabilities and Exposure) ID serves this purpose. The qualification data 600 includes the results from the qualification test 114. The qualification log 134 includes intermediate data output from the qualification test 114 that may be of use to administrators 192 in remediating the vulnerability.

The configuration data 300 includes data describing the types of qualification test 114 to be executed and the vulnerability scanner 102 output to associate with the qualification test 114. The configuration data 300 is used as an input to the parser module 118. The raw vulnerability data 400 includes the raw output of the vulnerability scanners 102. The raw vulnerability data 400 typically stores the output from a single run or session from the vulnerability scanners 102. The collated lists included in the target list 500 are lists of related vulnerabilities detected by the vulnerabilities scanners 102 based on a provider vulnerability ID.

The target system data 160 stores data related to one or more target system references 162, identifying a corresponding one or more target systems 180, against which the vulnerability scanners 102 are executed. Each target system reference 162 includes an IP address 164, contact name 166, contact information 168, and target system configuration 170. The IP address 164 is the IP address of the target system reference 162. The contact's name 166 stores the name of the contact. The contacts typically store contact information for one or more administrators 192. For example, “Joe Smith”. The contact information 168 stores one or more communication addresses. Examples include, email, phone number (for texting), instant messaging handles, and the like. For example, “joe.smith@company.com”. The target systems configuration 170 includes information about the characteristics of the target system reference 162. Examples can include the device type, operating system, applications installed, software versions, and the like.

As used herein, a target system 180 is any computing device capable of executing code and connected to the network 15. Examples include a server device, desktop device, laptop device, cellular phone, routing device, switching device, etc.

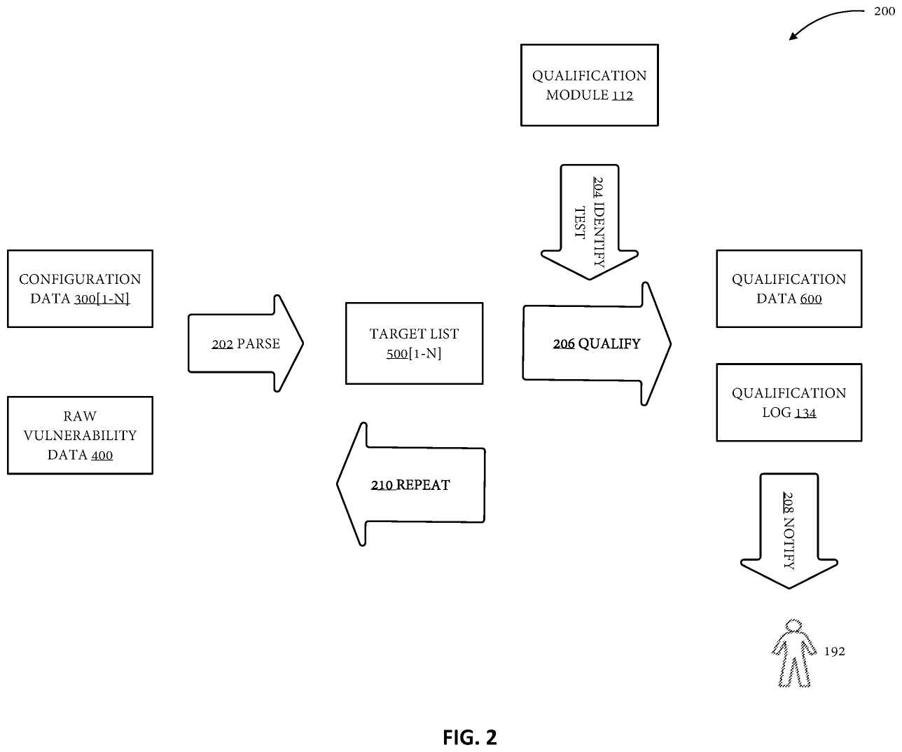

FIG. 2 is a flow diagram 200 of the vulnerability qualification system 100 showing the various data structures used to pass state information and results through the system, according to one or more embodiments. For each qualification test 114, the parsing module 118 parses 202 the raw vulnerability data 400 according to the configuration data 300 to produce the target list 500. The qualification module 112 identifies 204 the correct qualification test 114 to execute on the target list 500 based on the qualification test ID 116 in the target list 500. The qualification module 112 performs the qualification 206 using the checker module 120. The checker module 120 creates qualification data 600 and qualification log 134. The qualification module 112 transmits notifications 208 using the notification module 122. The process is repeated 210 for each stanza in the configuration data 300. In some embodiments, the collated lists 502 of the target list 500 are created one at a time and processed immediately thereafter. In some embodiments, all collated lists 502 of the target list 500 are created from the raw vulnerability data 400 in a batch, and then all qualification test 114 are executed in a batch.

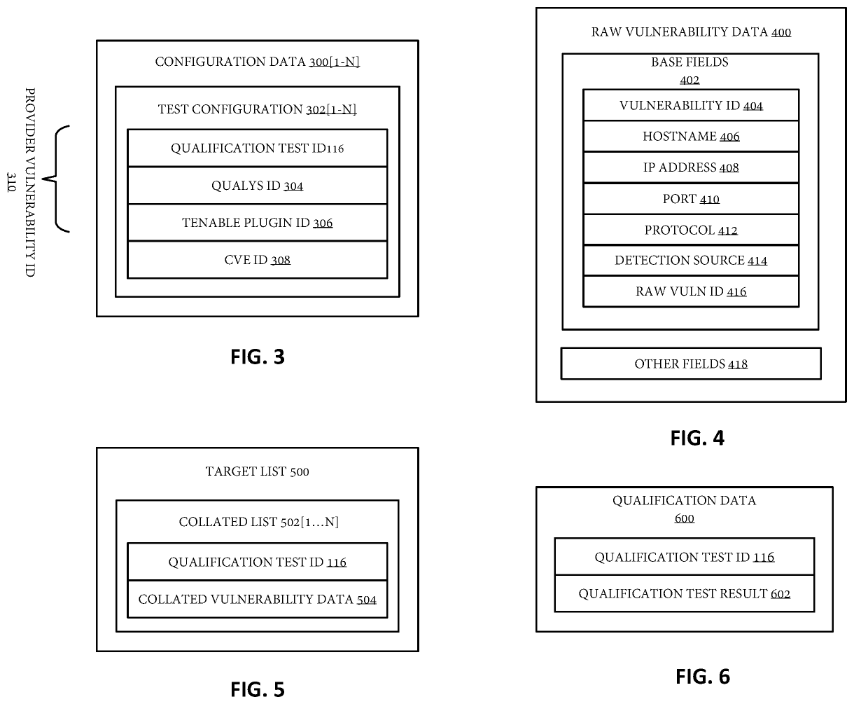

FIG. 3 is a block diagram of the configuration data 300 of FIG. 2 for specifying the configuration of the vulnerability qualification system 100, according to one or more embodiments. The configuration data 300 includes one or more test configurations 302. In one embodiment, each test configuration 302 includes a qualification test ID 116, Qualys ID 304, tenable plugin ID 306, and CVE ID 308. In other embodiments, the test configuration 302 elements can vary. In some embodiments, additional configuration elements can be included. The qualification test ID 116 uniquely identifies the qualification test 114 to be executed. The Qualys ID 304, tenable plugin ID 306, and CVE ID 308 are examples of provider vulnerability IDs 310, and identify vulnerabilities detected in the raw vulnerability data 400 to be included in the collated list 502 of the target list 500 for a respective qualification test 114. The Qualys ID 304 is an identifier found in raw vulnerability data 400 from a vulnerability scanner 102 from Qualys. The Tenable plugin ID 306 is an identifier found in raw vulnerability data 400 from a vulnerability scanner 102 from Tenable. The CVE ID 308 is an identifier found in raw vulnerability data 400 from other vulnerability scanners where the providers have agreed to use the CVE ID 308 as a standard identifier.

CVE, or Common Vulnerabilities and Exposures, is a standardized system for identifying and tracking security vulnerabilities in software and hardware products. Each CVE entry is assigned a unique identifier, making it easier for cybersecurity professionals to reference and discuss vulnerabilities. The CVE system enables the sharing of information about vulnerabilities, helping organizations coordinate efforts to mitigate the vulnerabilities and ensuring a common language for discussing security flaws in the technology industry.

FIG. 4 is a block diagram of the raw vulnerability data 400 of FIG. 2 received from vulnerability scanners 102 of the vulnerability qualification system 100, according to one or more embodiments. The raw vulnerability data 400 includes data produced from all of the vulnerability scanners 102 against all of the target systems 162 for a given execution cycle. The raw vulnerability data 400 will typically include multiple different types of vulnerabilities. The raw vulnerability data 400 includes base fields 402 and other fields 418. In one embodiment, each base field 402 includes a vulnerability ID 404, a hostname 406, an IP address 408, a port 410, a protocol 412, a detection source 414, a raw vulnerability ID 416, and other fields 418. In other embodiments, the base field 402 elements can vary. In some embodiments, additional related elements can be included. The vulnerability ID 404 is a unique ID assigned to each raw detection record within the raw vulnerability data 400. The hostname 406 is the name assigned to a target system 180 on the network 15. The IP address is the network routing address assigned to a target system 180 on the network 15. The port 410 is a number that is assigned to uniquely identify a network connection endpoint and to direct data to a specific service. The protocol 412 is an established set of rules that determine how data is transmitted between different devices in the same network. The detection source 414 is a designation of which source the raw detection came from (i.e., Qualys, Tenable, Wiz.io, unique ID number corresponding to the raw detection. Other fields 418 include one or more fields included in the raw vulnerability data 400 and not included in the base fields that are not required for the execution of the qualification test 114 in some embodiments.

FIG. 5 is a block diagram of the target list 500 of FIG. 2, according to one or more embodiments. The target list 500 is comprised of one or more collated list 502, where each collated list 502 is used as an input to a qualification test 114 of the vulnerability qualification system 100, according to one or more embodiments. In one embodiment, each collated list 502 includes a qualification test ID 116 and collated vulnerability data 504. In other embodiments, the collated list 502 elements can vary. In some embodiments, additional related elements can be included. The qualification test ID 116 uniquely identifies the qualification test 114 to be executed on the collated vulnerability data 504. In some embodiments, the collated vulnerability data 504 includes only the base fields 402 of the raw vulnerability data 400. However, the techniques disclosed herein are not limited thereto. The number and identity of the collated lists 502 generated and the provider vulnerability IDs included in each respective collated list 502, are dictated based on the configuration data 300. In some embodiments, the target list 500 is generated each time the vulnerability scanners 102 are executed. For example, daily or weekly. In some embodiments, the previous target list 500 is deleted when a new target list 500 is generated. In some embodiments, previous target lists 500 are logged for later reference when a new target list 500 is generated.

FIG. 6 is a block diagram of the qualification data 600 of FIG. 2 produced as an output of a qualification test 114 of the vulnerability qualification system 100, according to one or more embodiments. In one embodiment, each qualification data 600 includes a qualification test ID 116 and a qualification test result 602. In other embodiments, the qualification data 600 elements can vary. In some embodiments, additional related elements can be included. The qualification test ID 116 uniquely identifies the qualification test 114 that produced the qualification test result 602. As used herein, the qualification test result 602 can be any information identifying the level of need for remediation of the vulnerability. In some embodiments, the qualification test result 602 is represented as a Boolean (i.e., TRUE or FALSE). In some embodiments, the qualification test result 602 can have multiple values ranging between an inclusive minimum value and an inclusive maximum value. In some embodiments, the range is continuous. In some embodiments, the range is discrete. In some embodiments, the qualification test result 602 is represented by a numeric value, such as a floating-point value or discrete integer. In some embodiments, the qualification test result 602 is represented as an alphabetic character (e.g., A, B, C, and the like).

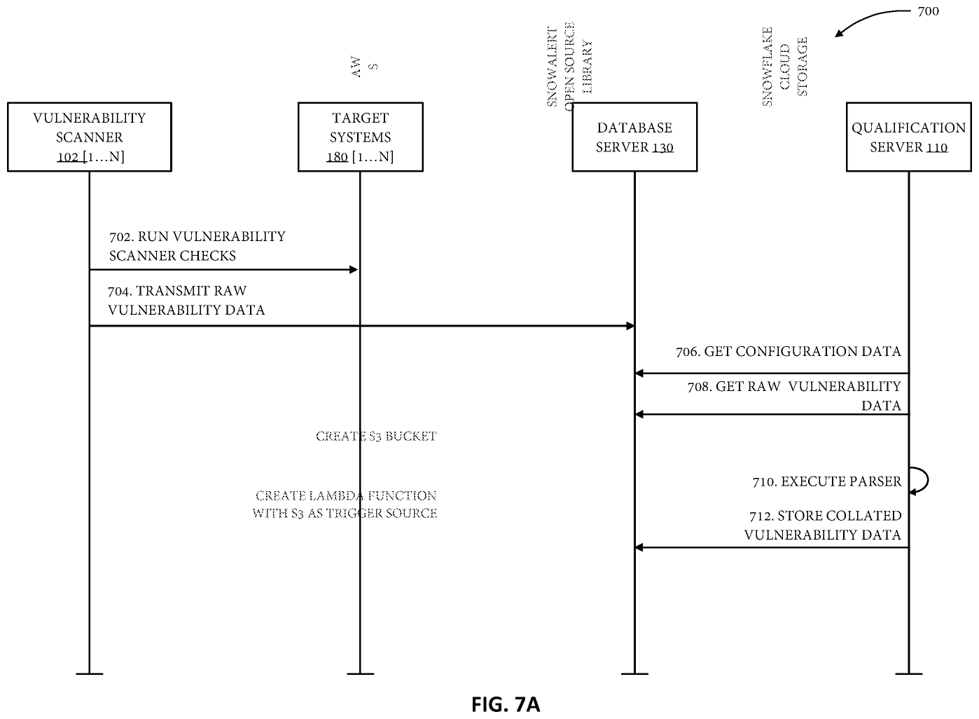

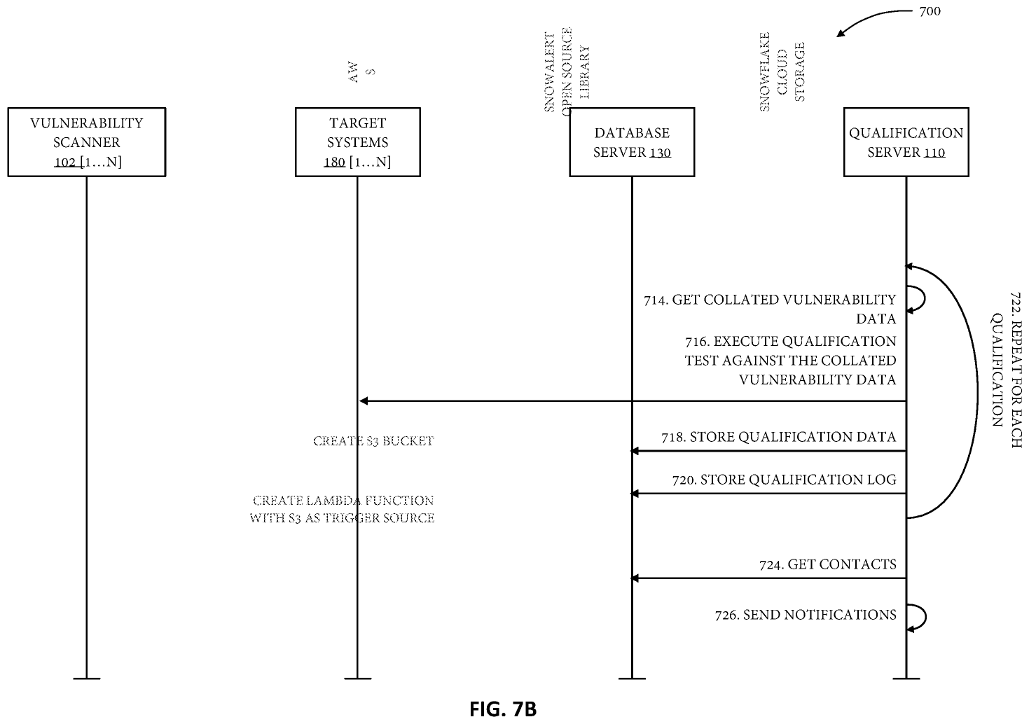

FIG. 7A is a conceptual illustration of a flowchart 700 for performing vulnerability qualification, according to various embodiments. At step 702, one or more vulnerability scanners 102 execute vulnerability detection of target systems 180, producing raw vulnerability data 400. In some embodiments, the vulnerability scanners 102 are commercial vulnerability scanners 102. Several commercial vulnerability scanners 102 are available to assist organizations in identifying and addressing security weaknesses within their systems. Nessus, developed by Tenable, is a widely used tool that helps detect vulnerabilities, configuration issues, and malware across networks and systems. Qualys Vulnerability Management offers a cloud-based platform for continuous monitoring, assessment, and remediation of security vulnerabilities. Rapid7 Nexpose is another prominent vulnerability management solution that aids in discovering, assessing, and prioritizing vulnerabilities. Acunetix focuses specifically on web application security, identifying issues such as SQL injection and cross-site scripting. OpenVAS, an open-source tool, has a commercial counterpart called the Greenbone Security Manager (GSM) developed by Greenbone. IBM Security Qradar Vulnerability Manager integrates vulnerability management with SIEM capabilities. Tenable.io is a cloud-based platform providing vulnerability management services. BeyondTrust Retina assists organizations in identifying, prioritizing, and remediating vulnerabilities. F-Secure Radar is a vulnerability and risk management solution, and Skybox Security Suite offers a range of tools, including vulnerability management, to assess and manage security postures.

At step 704, one or more vulnerability scanners 102 transmit the resulting raw vulnerability data 400 to the database server 130 for storage. The raw vulnerability data 400 stores information related to one or more detected vulnerabilities. In some embodiments, the raw vulnerability data 400 includes a vulnerability ID 404, a hostname 406, an IP address 408, a port 410, a protocol 412, a detection source 414, a raw vulnerability ID 416, and other fields 418.

At step 706, the qualification server 110 gets configuration data 300 from the database server 130. The configuration data 300 stores information related to the qualification test 114 to be performed by the qualification module 112. In some embodiments, the configuration data 300 includes one or more test configurations 302. Each test configuration 302 includes a qualification test ID 116, a Qualys ID 304, a tenable plugin ID 306, and a CVE ID 308. The configuration data 300 is typically defined and entered by an administrator 192. In some embodiments, the configuration data 300 can be generated automatically based on the contents of the raw vulnerability data 400.

At step 708, the qualification server 110 gets the raw vulnerability data 400 from the database server 130. In some embodiments, the qualification server 110 and the database server 130 are the same device. At step 710, the qualification server 110 executes the parser module 118 to produce the collated vulnerability data 504. In some embodiments, the collated vulnerability data 504 represents raw vulnerability data 400 for one target system 180 where the other fields 418 have been removed. In some embodiments, the contents of the collated vulnerability data 504 are sorted based on provider vulnerability ID 310. At step 712, the collated vulnerability data 504 can be optionally transmitted to the database server 130 for storage.

FIG. 7B is a conceptual illustration of a flowchart 700 for performing vulnerability qualification, according to various embodiments. FIG. 7B starts off where FIG. 7A ends. At step 714, the collated vulnerability data 504 is optionally received from the database server 130. At step 716, the qualification server 110 executes the checker module 120 against the collated vulnerability data 504 to produce qualification data 600. The checker module 120 is part of the qualification module 112 running on the qualification server 110. The checker module 120 determines the qualification test 114 to execute against the collated vulnerability data 504 based on the qualification test ID 116 found in the collated vulnerability data 504.

At step 718, the qualification server 110 stores the qualification data 600 at the database server 130. The qualification data 600 includes a qualification test ID 116 and a qualification test result 602. The qualification test result 602 can be any information identifying the level of need for remediation of the detected vulnerability. At step 720, the qualification server 110 stores the qualification log 134 at the database server 130.

At step 722, the qualification process is repeated for each stanza in the configuration data 300. In some embodiments, the collated lists 502 in the target list 500 are created one at a time and processed immediately thereafter. In some embodiments, all collated lists 502 in the target list 500 are created from the raw vulnerability data 400 in a batch, and then all qualification test 114 are executed in a batch.

At step 724, the qualification server 110 gets the contact's name 166 and contact info 168 from the database server 130. At step 726, the qualification server 110 sends notifications to one or more administrators 192 using the contact's name 166 and contact info 168. In some embodiments, the notification can include information identifying the qualification test 114 executed and the qualification data 600. In some embodiments, the notification is only transmitted if the qualification data 600 qualifies a vulnerability.

### Process Overview

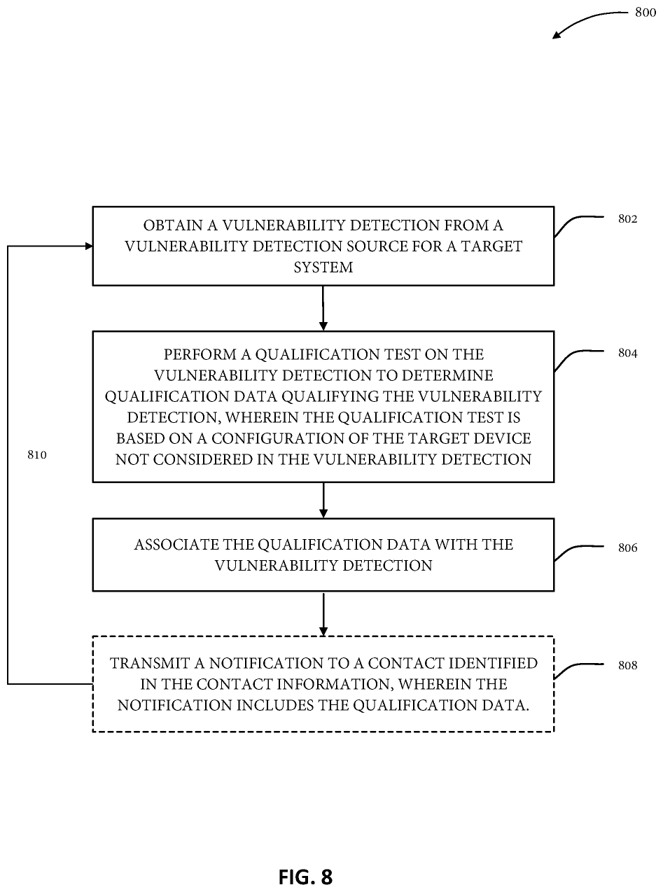

FIG. 8 is a flow diagram 800 of method steps for the vulnerability qualification system, according to various embodiments. Although the method steps are described in conjunction with the systems of FIGS. 1-7, persons of ordinary skill in the art will understand that any system configured to perform the method steps, in any order, is within the scope of the present disclosure.

At step 802, the qualification module 112 obtains a vulnerability detection from a vulnerability scanner 102 for a target system 180. The vulnerability detection can be one of a plurality of vulnerability detections in the raw vulnerability data 400. The parser module 118 processes the raw vulnerability data 400 to produce the collated vulnerability data 504. The collated vulnerability data 504 represents raw vulnerability data 400 for one or more target systems 180 for a single provider vulnerability ID 310 where the other fields 418 have been removed. In some embodiments, the contents of the collated vulnerability data 504 are sorted based on provider vulnerability ID 310.

At step 804, the checker module 120 of the qualification module 112 performs a qualification test 114 on the vulnerability detection to determine qualification data 600 quantifying a veracity of the vulnerability detection, wherein the qualification test 114 is based on a target system configuration 170 not considered in the vulnerability detection by the vulnerability scanner 102. The qualification test 114 operates on the qualification test data 132 stored at the database server 130. In some embodiments, the qualification server 110 and the database server 130 are the same device. The checker module 120 operates on the collated vulnerability data 504 to produce the qualification data 600. The checker module 120 determines the qualification test 114 to execute against the collated vulnerability data 504 based on the qualification test ID 116 found in the collated vulnerability data 504.

At step 806, the checker module 120 of the qualification module 112 associates the qualification data 600 with the vulnerability detection. In some embodiments, the association takes the form of storing the qualification data 600 in the same records as the raw vulnerability data for a given session or test run. In some embodiments, the association is accomplished through a database key linking the qualification data 600 and raw vulnerability data 400 for a given session or test run. As used herein, any mechanism unambiguously linking the qualification data 600 and raw vulnerability data 400 (vulnerability detection) for a given session or test run is to be considered an association.

At step 808, notification module 122 of qualification module 112 optionally transmits a notification to a contact (contact name 166) identified in contact information 168, wherein the notification includes qualification data 600. In some embodiments, the notification is sent to a system administrator 192, responsible for taking the steps to remediate the vulnerability identified by the vulnerability detection and qualified/verified by the qualification data 600 which includes the qualification test result 602 quantifying the veracity of the vulnerability detection.

At step 810, the process 800 is repeated for each stanza in the configuration data 300. In some embodiments, the collated lists 502 in the target list 500 are created one at a time and processed immediately thereafter. In some embodiments, all collated lists 502 in the target list 500 are created from the raw vulnerability data 400 in a batch, and then all qualification tests 114 are executed in a batch. In some embodiments, the process 800 is scheduled and can occur on a periodic basis.

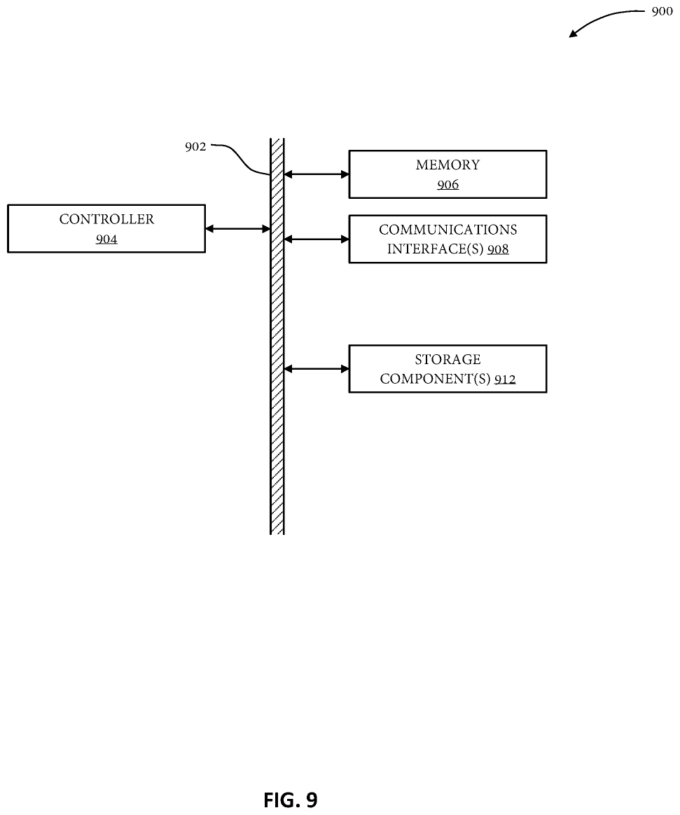

Referring to FIG. 9, an exemplary server device hardware architecture configured to implement one or more aspects of the various embodiments is shown 900. The qualification server 110 adheres to the exemplary server device hardware architecture. The qualification server 110 includes a controller 904 communicatively connected to memory 906, one or more communications interfaces 908, and one or more secondary storage devices 912 by a bus 902 or similar mechanism. The controller 904 is, for example, a microprocessor, digital ASIC, FPGA, or the like. In this embodiment, the controller 904 is a microprocessor, and the software application, such as the qualification module 112, is implemented in software and stored in the memory 906 for execution by the controller 904. However, the present disclosure is not limited thereto. The aforementioned module may be implemented in software, hardware, or a combination thereof. The servers also include a communication interface 908 enabling the servers to connect to the network 15. For example, the communications interface 908 is a wired interface such as an Ethernet interface. However, the present disclosure is not limited thereto. The servers include one or more secondary storage components 912. The secondary storage components 912 are digital data storage components such as, for example, one or more hard disk drives. However, the present invention is not limited thereto. In some embodiments, the server is one or more rack mount servers and/or blade servers. Server devices are often optimized for speed, throughput, power consumption, and reliability.

Some common examples of exploits include the “Anonymous FTP” exploit, “Anonymous Telnet” exploit, “EternalBlue” exploit, “HP Exec IntegUtil” exploit, “IPMI Authentication Bypass” exploit, “Java Debug Wire Protocol” exploit, Shellshock exploit, “SMTP Relay” exploit, “Unauthenticated Jenkins” exploit, “Unauthenticated MongoDB” exploit, “WebLogicRCE” exploit, “BlueKeep” exploit, “Java JMX Insecure Config” exploit, “SMB Ghost” exploit, and the “F5 RCE” exploit. As used herein, an exploit is a piece of software or a sequence of commands designed to take advantage of a vulnerability in a computer system, application, or network, allowing unauthorized access or unintended actions. As used herein, a malicious actor refers to an individual, group, or entity that engages in harmful activities with the intent to compromise computer systems, networks, or data. These actors may include hackers, cybercriminals, or other individuals seeking to exploit vulnerabilities for malicious purposes. For purposes of illustration, additional details on the “Anonymous FTP” and Java Debug Wire Protocol” are described below.

### Anonymous Ftp

The “Anonymous FTP” exploit involves attempting to connect to a target system 180 on a specified port using the FTP protocol. If the connection is successful, a command is issued to list the contents of the root folder, allowing a user to download/upload/modify files on the target system 180. A malicious actor with access to a network can login to this device via FTP without requiring a username and password. FTP stands for File Transfer Protocol. FTP is a standard network protocol used for transferring files between a client and a server on a computer network, typically the Internet. FTP allows users to upload, download, and manage files and directories on a remote server. FTP is widely used for website maintenance, software updates, and sharing files across networks. There are also secure versions of FTP, like FTPS (FTP Secure) and SFTP (SSH File Transfer Protocol), which encrypt the data being transferred to enhance security.

The conventional approach of a vulnerability scanner 102 to detect the “Anonymous FTP” vulnerability is to check for an open port 21 on the target system 180. The qualification test 114 for FTP improves on the conventional approach by attempting to connect to the FTP service, list the contents of the directory, and analyze any records returned from the target system 180. In some embodiments, if the qualification test 114 is successful, then a TRUE result is recorded as the qualification test result 602 (the detected vulnerability has passed qualification). Otherwise, a FALSE result is recorded as the qualification test result 602 (the detected vulnerability has failed qualification).

### Java Debug Wire Protocol

The “Java Debug Wire Protocol” exploit involves attempting to leverage an exposed JDWP debugger to execute commands on a target system 180. A malicious actor with access to a network, such as network 15, can execute arbitrary Java code on target system 180 due to a lack of authentication being required on the JDWP residing on the target system 180. JDWP stands for Java Debug Wire Protocol, and it is a protocol used for debugging applications written in the Java programming language. JDWP enables communication between a debugger and a Java Virtual Machine (JVM) to facilitate debugging tasks, such as setting breakpoints, inspecting variables, and stepping through code. JDWP allows developers to interact with and monitor the execution of Java programs to find and fix bugs and issues in their code. Debugger tools like Eclipse, IntelliJ IDEA, and others use JDWP to provide debugging capabilities for Java applications.

The conventional approach by a vulnerability scanner 102 for detecting the “Java Debug Wire Protocol” vulnerability is to check a banner returned in response to pinging the target system 180. The qualification test 114 for “Java Debug Wire Protocol” improves on the conventional approach by attempting to send a connection payload to a JWDP debugger console on target system 180, run the “whoami” command, and analyze results returned from the target system 180. In some embodiments, if the qualification test 114 for “Java Debug Wire Protocol” is successful, then a TRUE result is recorded (the detected vulnerability has passed qualification). Otherwise, a FALSE result is recorded (the detected vulnerability has failed qualification).

In sum, techniques are disclosed for the qualifying a vulnerability detection for remediation. One or more vulnerability scanners are executed periodically to produce raw vulnerability data. The raw vulnerability data identifies one or more vulnerability detections. The qualification module processes the raw vulnerability data based on configuration data to produce a target list. The target list includes collated vulnerability data for one or more qualification tests. The one or more qualification tests operate on the collated vulnerability data to produce qualification data, wherein the qualification data includes a qualification test result for each qualification test. The qualification test results each respectively identified if a vulnerability detection has been qualified. A vulnerability detection that has been qualified is vulnerability detection requiring remediation. The remediation of a qualified vulnerability detection can be performed by an administrator. The disclosed techniques include developing code modules (qualification tests) that are directed towards qualifying a certain type of security vulnerability, where new code modules can be developed as new security vulnerabilities are identified by the vulnerability scanners. The code modules can be run with the same frequency and in tandem with the vulnerability scanners. The code modules can produce log data, providing additional detail around the qualification test performed to aid in later remediation. The code modules can store resultant qualification data with the output from the vulnerability scanners to form a complete record of detected security vulnerabilities.

At least one technical advantage of the disclosed techniques relative to the prior art is that the disclosed techniques automate the prioritization and remediation of security vulnerabilities detected by vulnerability scanners. The proposed techniques qualify the security vulnerabilities detected by the vulnerability scanners by applying additional context to the detected security vulnerabilities to determine if they represent a true security vulnerability requiring remediation. The additional context applied to qualify the vulnerabilities represents one or more configuration elements not considered by the vulnerability scanners. The technical advantages provide one or more technological advancements over the prior art approaches.

1. In some embodiments, a method of qualifying a vulnerability detection for remediation comprising the steps of: obtaining a vulnerability detection from a vulnerability scanner for a target system; determining qualification data qualifying the vulnerability detection, wherein the qualification data is based on a configuration of the target system excluded in the vulnerability detection from the vulnerability scanner; and associating the qualification data with the vulnerability detection.

2. The method of clause 1, comprising: re-performing determining qualification data each time a new vulnerability detection is obtained from the vulnerability scanner for the target system.

3. The method of clauses 1 or 2, wherein obtaining the vulnerability detection from the vulnerability scanner comprises: obtaining a plurality of vulnerability detections from a plurality of vulnerability scanners applied against a plurality of target systems residing in a network.

4. The method of clauses 1-3, wherein each of the plurality of vulnerability detections includes: a provider vulnerability identifier identifying a type of the vulnerability detection, a target system identifier identifying a target system against which a vulnerability was detected, and a source identifier identifying the vulnerability scanner.

5. The method of clauses 1-4, further comprising: determining configuration data for initializing a vulnerability qualification system identifying: one or more qualification tests, and one or more provider vulnerability identifiers associated with each qualification test; and segmenting the plurality of vulnerability detections based on the provider vulnerability identifiers into one or more lists, wherein each of the one or more lists includes one or more vulnerability detections to be qualified using a qualification test identified based on a qualification identifier included in the configuration data.

6. The method of clauses 1-5, wherein the qualification data includes: a qualification identifier identifying a qualification test performed, and a qualification test result characterizing the vulnerability detection.

7. The method of clauses 1-6, wherein determining the qualification data qualifying the vulnerability detection comprises: determining a plurality of target systems associated with a same provider vulnerability identifier; and performing a same qualification test on each target system in the plurality of target systems.

8. The method of clauses 1-7, wherein determining the qualification data qualifying the vulnerability detection comprises: identifying a qualification test to perform based on matching a provider vulnerability identifier to the qualification test.

9. The method of clauses 1-8, wherein the qualification data includes a qualification test result identifying the vulnerability detection as one of requiring remediation or not requiring remediation.

10. The method of clauses 1-9, wherein the configuration of a target system includes one or more of: an operating system running on the target system, a version of an operating system running on the target system, a software application running on the target system, a version of an application running on the target system, a networking port open on the target system, and a networking protocol running on the target system.

11. In some embodiments, one or more non-transitory computer-readable media storing instructions that, when executed by one or more processors, cause the one or more processors to perform the steps of: obtaining a vulnerability detection from a vulnerability scanner for a target system; determining qualification data qualifying the vulnerability detection, wherein the qualification data is based on a configuration of the target system excluded in the vulnerability detection from the vulnerability scanner; and associating the qualification data with the vulnerability detection.

12. The one or more non-transitory computer-readable media of clause 11, wherein the qualification data includes: a qualification identifier identifying a qualification test performed, and a qualification test result characterizing the vulnerability detection.

13. The one or more non-transitory computer-readable media of clause 11 or 12, wherein determining the qualification data qualifying the vulnerability detection comprises: determining a plurality of target systems associated with a same provider vulnerability identifier; and performing a same qualification test on each target system in the plurality of target systems.

14. The one or more non-transitory computer-readable media of clauses 11-13, wherein determining the qualification data qualifying the vulnerability detection comprises: identifying a qualification test to perform based on matching a provider vulnerability identifier to the qualification test.

15. The one or more non-transitory computer-readable media of clauses 11-14, wherein the qualification data includes a qualification test result identifying the vulnerability detection as one of requiring remediation or not requiring remediation.

16. The one or more non-transitory computer-readable media of clauses 11-15, wherein the configuration of a target system includes one or more of: an operating system running on the target system, a version of an operating system running on the target system, a software application running on the target system, a version of an application running on the target system, a networking port open on the target system, and a networking protocol running on the target system.

17. The one or more non-transitory computer-readable media of clauses 11-16, wherein associating the qualification data with the vulnerability detection comprises storing the qualification data with the vulnerability detection in one or more of a database and a file system.

18. The one or more non-transitory computer-readable media of clauses 11-17 further comprising: obtaining contact information associated with the target system against which the vulnerability detection was made; and transmitting a notification to a contact identified in the contact information, wherein the notification includes the qualification data.

19. The one or more non-transitory computer-readable media of clauses 11-18 further comprising: storing intermediate results from determining qualification data in a qualification log.

20. In some embodiments, a system comprising: a memory storing a qualification application; and a processor coupled to the memory that executes a qualification module to perform the steps of: obtaining a vulnerability detection from a vulnerability scanner for a target system; determining qualification data qualifying the vulnerability detection, wherein the qualification data is based on a configuration of the target system excluded in the vulnerability detection from the vulnerability scanner; and associating the qualification data with the vulnerability detection.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method of qualifying a vulnerability detection for remediation comprising:
obtaining a vulnerability detection from a vulnerability scanner for a target system;
determining qualification data qualifying the vulnerability detection, wherein the qualification data is based on a configuration of the target system excluded in the vulnerability detection from the vulnerability scanner; and
associating the qualification data with the vulnerability detection.

2. The method of claim 1, comprising:
re-performing determining qualification data each time a new vulnerability detection is obtained from the vulnerability scanner for the target system.

3. The method of claim 1, wherein obtaining the vulnerability detection from the vulnerability scanner comprises:
obtaining a plurality of vulnerability detections from a plurality of vulnerability scanners applied against a plurality of target systems residing in a network.

4. The method of claim 3, wherein each of the plurality of vulnerability detections includes:
a provider vulnerability identifier identifying a type of the vulnerability detection,
a target system identifier identifying a target system against which a vulnerability was detected, and
a source identifier identifying the vulnerability scanner.

5. The method of claim 4, further comprising:
determining configuration data for initializing a vulnerability qualification system identifying:
one or more qualification tests, and
one or more provider vulnerability identifiers associated with each qualification test; and
segmenting the plurality of vulnerability detections based on the provider vulnerability identifiers into one or more lists, wherein each of the one or more lists includes one or more vulnerability detections to be qualified using a qualification test identified based on a qualification identifier included in the configuration data.

6. The method of claim 1, wherein the qualification data includes:
a qualification identifier identifying a qualification test performed, and
a qualification test result characterizing the vulnerability detection.

7. The method of claim 1, wherein determining the qualification data qualifying the vulnerability detection comprises:
determining a plurality of target systems associated with a same provider vulnerability identifier; and
performing a same qualification test on each target system in the plurality of target systems.

8. The method of claim 1, wherein determining the qualification data qualifying the vulnerability detection comprises:
identifying a qualification test to perform based on matching a provider vulnerability identifier to the qualification test.

9. The method of claim 1, wherein the qualification data includes a qualification test result identifying the vulnerability detection as one of requiring remediation or not requiring remediation.

10. The method of claim 1, wherein the configuration of a target system includes one or more of:
an operating system running on the target system,
a version of an operating system running on the target system,
a software application running on the target system,
a version of an application running on the target system,
a networking port open on the target system, and
a networking protocol running on the target system.

11. One or more non-transitory computer-readable media storing instructions that, when executed by one or more processors, cause the one or more processors to perform the steps of:
obtaining a vulnerability detection from a vulnerability scanner for a target system;
determining qualification data qualifying the vulnerability detection, wherein the qualification data is based on a configuration of the target system excluded in the vulnerability detection from the vulnerability scanner; and
associating the qualification data with the vulnerability detection.

12. The one or more non-transitory computer-readable media of claim 11, wherein the qualification data includes:
a qualification identifier identifying a qualification test performed, and
a qualification test result characterizing the vulnerability detection.

13. The one or more non-transitory computer-readable media of claim 11, wherein determining the qualification data qualifying the vulnerability detection comprises:
determining a plurality of target systems associated with a same provider vulnerability identifier; and
performing a same qualification test on each target system in the plurality of target systems.

14. The one or more non-transitory computer-readable media of claim 11, wherein determining the qualification data qualifying the vulnerability detection comprises:
identifying a qualification test to perform based on matching a provider vulnerability identifier to the qualification test.

15. The one or more non-transitory computer-readable media of claim 11, wherein the qualification data includes a qualification test result identifying the vulnerability detection as one of requiring remediation or not requiring remediation.

16. The one or more non-transitory computer-readable media of claim 11, wherein the configuration of a target system includes one or more of:
an operating system running on the target system,
a version of an operating system running on the target system,
a software application running on the target system,
a version of an application running on the target system,
a networking port open on the target system, and
a networking protocol running on the target system.

17. The one or more non-transitory computer-readable media of claim 11, wherein associating the qualification data with the vulnerability detection comprises:
storing the qualification data with the vulnerability detection in one or more of a database and a file system.

18. The one or more non-transitory computer-readable media of claim 11 further comprising:
obtaining contact information associated with the target system against which the vulnerability detection was made; and
transmitting a notification to a contact identified in the contact information, wherein the notification includes the qualification data.

19. The one or more non-transitory computer-readable media of claim 11 further comprising:
storing intermediate results from determining qualification data in a qualification log.

20. A system comprising:
a memory storing a qualification module; and
a processor coupled to the memory that executes a qualification module to perform the steps of:
obtaining a vulnerability detection from a vulnerability scanner for a target system;
determining qualification data qualifying the vulnerability detection, wherein the qualification data is based on a configuration of the target system excluded in the vulnerability detection from the vulnerability scanner; and
associating the qualification data with the vulnerability detection.
